(19) United States
(12) Patent Application Publication
(10) Pub. No.: US 2026/0052508 A1
(43) Pub. Date: Feb. 19, 2026

(54) INFORMATION PROCESSING APPARATUS, CONTROL METHOD, AND STORAGE MEDIUM THAT STORES ONE OR MORE PROGRAMS

(71) Applicant: CANON KABUSHIKI KAISHA, Tokyo (JP)

(72) Inventor: MASATAKA IURA, Chiba (JP)

(21) Appl. No.: 19/294,980

(22) Filed: Aug. 8, 2025

(30) Foreign Application Priority Data
Aug. 19, 2024 (JP) 2024-137859

(51) Int. Cl. H04W 64/00; H04W 76/14; H04W 88/02

(52) U.S. Cl. CPC H04W 64/003; H04W 76/14; H04W 88/02

(57) ABSTRACT

Based on an operation indicating that a communication apparatus that a user desires to use is not a communication apparatus of a predetermined type, a first process for connection for establishing a wireless connection of the communication apparatus according to a first processing method is executed. Based on an operation indicating that the communication apparatus is a communication apparatus of the predetermined type, at least one process out of: a second process for connection for establishing a wireless connection of the communication apparatus according to a second processing method that is different from the first processing method; and a second process for search for searching for the communication apparatus according to a second search method that is different from the first search method is executed.

### BACKGROUND

### Field of the Technology

The present disclosure relates to an information processing apparatus, a control method, and a storage medium that stores one or more programs.

### Description of the Related Art

Japanese Patent Laid-Open No. 2019-75832 discloses a technique in which an information processing apparatus such as a personal computer (PC) transmits information relating to an access point to a communication apparatus such as a printer to connect the communication apparatus and the external apparatus and thereby establishes a state in which the information processing apparatus and the communication apparatus can communicate with one another.

### SUMMARY

The present disclosure provides an information processing apparatus, a control method, and a storage medium that stores one or more programs that improve the user-friendliness of a function for establishing a state in which an information processing apparatus and a communication apparatus can communicate with one another.

The present disclosure in one aspect provides a method for controlling an information processing apparatus, the control method comprising: executing a first process for search for, according to a first search method, searching for one or more communication apparatuses on a network to which the information processing apparatus belongs; receiving, from a user, a predetermined operation indicating that a communication apparatus that the user desires to use has not been discovered even though the first process for search has been executed; in a case where the predetermined operation is received, displaying a confirmation screen for confirming whether or not the communication apparatus that the user desires to use is a communication apparatus of a predetermined type; based on an operation indicating that the communication apparatus that the user desires to use is not a communication apparatus of the predetermined type being received by the information processing apparatus from the user after the confirmation screen is displayed, executing a first process for connection for establishing a wireless connection of the communication apparatus according to a first processing method in which information about an external access point that is an access point outside the information processing apparatus is transmitted to the communication apparatus; and based on an operation indicating that the communication apparatus that the user desires to use is a communication apparatus of the predetermined type being received by the information processing apparatus from the user after the confirmation screen is displayed, executing at least one process out of: a second process for connection for establishing a wireless connection of the communication apparatus according to a second processing method that is different from the first processing method; and a second process for search for searching for the communication apparatus according to a second search method that is different from the first search method.

According to the present disclosure, the user-friendliness of a function for establishing a state in which an information processing apparatus and a communication apparatus can communicate with one another can be improved.

Features of the present disclosure will become apparent from the following description of embodiments with reference to the attached drawings. The following description of embodiments are described by way of example.

### BRIEF DESCRIPTION OF THE DRAWINGS

FIGS. 1A and 1B are diagrams illustrating configurations of a system.

FIG. 2 is a diagram illustrating configurations of apparatuses.

FIG. 3 is a flowchart illustrating processing executed by an application.

FIG. 4 is a diagram illustrating a screen displayed by the application.

FIG. 5 is a diagram illustrating a screen displayed by the application.

FIG. 6 is a diagram illustrating a screen displayed by the application.

FIG. 7 is a flowchart illustrating processing executed by the application.

FIG. 8 is a diagram illustrating a screen displayed by the application.

FIG. 9 is a diagram illustrating a screen displayed by the application.

FIG. 10 is a diagram illustrating a screen displayed by the application.

FIG. 11 is a flowchart illustrating processing executed by the application.

FIG. 12 is a diagram illustrating a screen displayed by the application.

FIG. 13 is a diagram illustrating a screen displayed by the application.

FIG. 14 is a diagram illustrating a screen displayed by the application.

FIGS. 15A and 15B are flowcharts illustrating processing executed by the application.

FIG. 16 is a diagram illustrating a screen displayed by the application.

FIG. 17 is a diagram illustrating a screen displayed by the application.

FIG. 18 is a diagram illustrating a screen displayed by the application.

FIG. 19 is a diagram illustrating a screen displayed by the application.

FIG. 20 is a flowchart illustrating processing executed by the application.

FIG. 21 is a diagram illustrating a screen displayed by the application.

### DESCRIPTION OF THE EMBODIMENTS

Hereinafter, embodiments will be described in detail with reference to the attached drawings. Note, the following embodiments are not intended to limit the scope of the disclosure. Multiple features are described in the embodiments, but limitation is not made the disclosure that requires all such features, and multiple such features may be combined as appropriate. Furthermore, in the attached drawings, the same reference numerals are given to the same or similar configurations, and redundant description thereof is omitted.

Communication apparatuses of certain models may not support the technique in which information relating to an access point is transmitted from an information processing apparatus to a communication apparatus to connect the communication apparatus and the external apparatus. Thus, in order to establish a state in which an information processing apparatus and a communication apparatus can communicate with one another, it is necessary to present a user with an appropriate means in accordance with the model of the communication apparatus that the user desires to use.

According to the present disclosure, the user-friendliness of a function for establishing a state in which an information processing apparatus and a communication apparatus can communicate with one another can be improved.

### First Embodiment

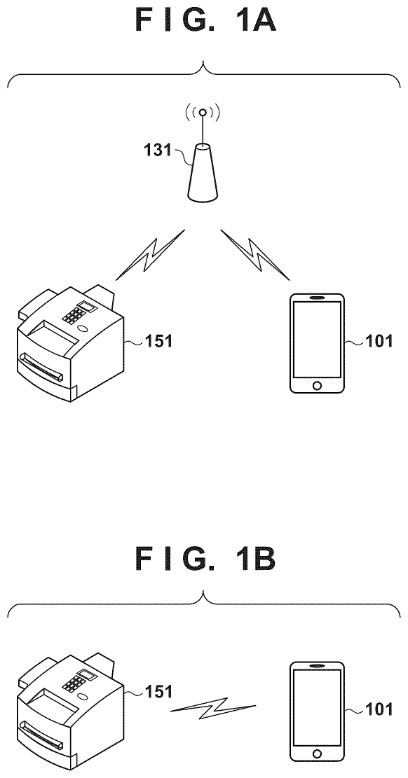

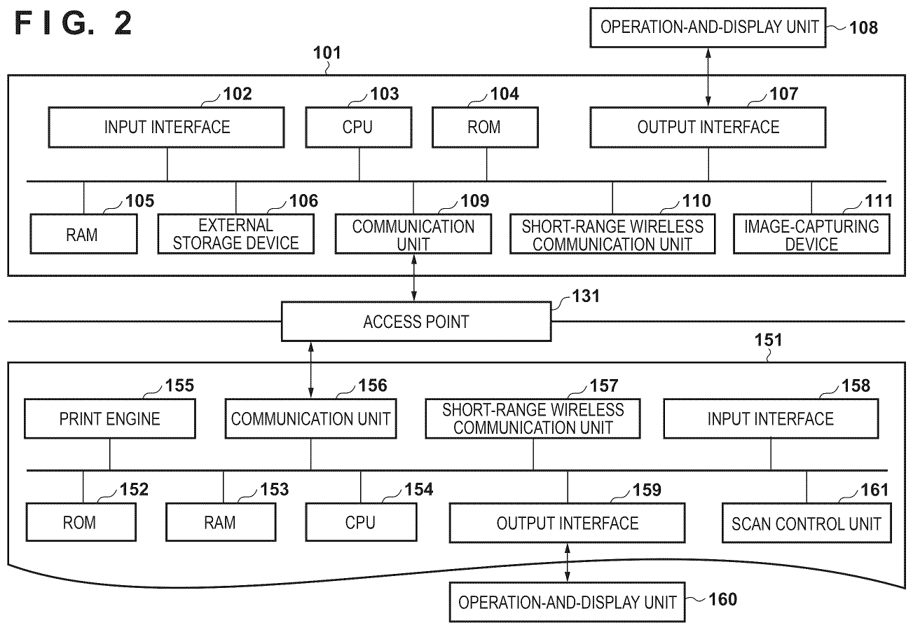

With reference to FIGS. 1A, 1B, and 2, an information processing apparatus according to the present embodiment will be described. A smartphone will be described in the present embodiment as an example of an information processing apparatus; however, there is no limitation to this, and information processing apparatuses of various types, such as a portable terminal, a laptop PC, a tablet terminal, a personal digital assistant (PDA), or a digital camera, are applicable. Furthermore, a printer will be described in the present embodiment as an example of a communication apparatus; however, there is no limitation to this, and communication apparatuses of various types are applicable, as long as the apparatus can communicate with the information processing apparatus. For example, in the case of printers, application is possible to inkjet printers, full-color laser beam printers, monochrome printers, etc. Furthermore, application is possible not only to printers but also to copiers, facsimile devices, portable terminals, smartphones, laptop PCs, tablet terminals, personal digital assistants (PDAs), digital cameras, etc. Besides these, application is possible also to multifunctional printers provided with a copy function, a facsimile function, and a printing function.

### <Hardware Configurations of Apparatuses>

With reference to the block diagram in FIG. 2, configurations of an information processing apparatus 101 and a communication apparatus 151 that can communicate with the information processing apparatus 101, which are included in a communication system according to the present embodiment, will be described. Furthermore, while description will be provided in the present embodiment taking the following configurations as an example, there is no limitation to the configurations illustrated in FIG. 2.

The information processing apparatus 101 includes an input interface 102, a CPU 103, a ROM 104, a RAM 105, an external storage device 106, an output interface 107, an operation-and-display unit 108, a communication unit 109, a short-range wireless communication unit 110, an image-capturing device 111, etc. The input interface 102 is an interface for receiving data input and operation instructions from a user, and is formed from a physical keyboard, displayed buttons, a touch panel, and/or the like. Note that a configuration may be adopted such that the later-described output interface 107 and the input interface 102 are integrated into a single component so that the output of screens and the reception of operations from the user are performed by the same component.

The CPU 103 is a system controller, and controls the entire information processing apparatus 101. The ROM 104 stores therein fixed data such as an embedded operating system (hereinafter “OS”) program, data tables, and control programs to be executed by the CPU 103. In the present embodiment, the control programs stored in the ROM 104 perform software execution control such as scheduling, task switching, and interruption processing under management by the embedded OS stored in the ROM 104.

The RAM 105 is formed from a static random-access memory (SRAM) or the like that requires a backup power supply. Note that, because data in the RAM 105 is retained by an unillustrated primary battery for data backup, important data such as program control variables can be stored non-volatilely. Furthermore, memory areas storing setting information of the information processing apparatus 101, management data of the information processing apparatus 101, etc., are also provided in the RAM 105. Furthermore, the RAM 105 is also used as the main memory and the work memory of the CPU 103.

The external storage device 106 includes a setup application program (hereinafter “setup application”) that has a function for communicating with the communication apparatus 151 and has a function for executing network connection setup processing for connecting the communication apparatus 151 to an external access point. The setup application runs on the CPU 103. Furthermore, in addition to the setup application, the external storage device 106 has stored therein an application that has a printing function for causing the communication apparatus 151 to execute printing and a scanning function for causing the communication apparatus 151 to execute scanning. However, there is no limitation to such a configuration, and the application may be an application that has only one of the printing function and the scanning function or an application having other functions. For example, the application may be the above-described setup application. For example, the external access point is the later-described access point 131.

Furthermore, the external storage device 106 includes various programs, such as a print information generation program for generating print information that can be interpreted by the communication apparatus 151, and an information transmission/reception control program for performing transmission and reception with the communication apparatus 151 connected via the communication unit 109. Such programs may be included in the above-described application, or may be configured separately from the application. Furthermore, the external storage device 106 stores therein various types of information to be used by these programs. Furthermore, the external storage device 106 also stores therein image data obtained via the communication unit 109 from other information processing apparatuses and the Internet.

The output interface 107 is an interface that performs control for allowing the operation-and-display unit 108 to display data and provide notifications regarding the state of the information processing apparatus 101. The operation-and-display unit 108 is formed from light-emitting diodes (LEDs), a liquid crystal display (LCD), etc., and displays data and provides notifications regarding the state of the information processing apparatus 101. Note that input from the user may be received via the operation-and-display unit 108 by installing a software keyboard including keys such as numerical input keys, mode setting keys, an enter key, a cancel key, and a power key on the operation-and-display unit 108.

The communication unit 109 is a component for connecting to apparatuses such as the communication apparatus 151 to execute data communication. For example, the communication unit 109 can connect to access points (unillustrated) inside the communication apparatus 151. By the communication unit 109 and the access points inside the communication apparatus 151 being connected, the information processing apparatus 101 and the communication apparatus 151 can communicate with one another. In the following, an access point may be referred to as “AP”. Note that the communication unit 109 may communicate directly with the communication apparatus 151 via wireless communication, or may communicate with the communication apparatus 151 via an access point 131 that is present outside both the information processing apparatus 101 and the communication apparatus 151. As the wireless communication method, IEEE 802.11 series communication standards are used in the present embodiment. Note that, specifically, the IEEE 802.11 series communication standards are known as Wi-Fi (registered trademark). The communication unit 109 can communicate with external servers such as a cloud server via the access point 131.

Furthermore, as examples of the access point 131, devices such as a wireless LAN router can be mentioned, for example. Note that, in the present embodiment, the method in which the information processing apparatus 101 and the communication apparatus 151 are directly connected without an external access point therebetween is referred to as a direct connection method. Furthermore, the method in which the information processing apparatus 101 and the communication apparatus 151 are connected via the external access point 131 is referred to as an infrastructure connection method.

The short-range wireless communication unit 110 is a component for establishing short-range wireless connection with apparatuses such as the communication apparatus 151 to execute data communication, and performs communication based on a communication method different from that of the communication unit 109. For example, the short-range wireless communication method used by the short-range wireless communication unit 110 is Bluetooth (registered trademark) or Near-field communication (NFC). Bluetooth may be Bluetooth Classic or Bluetooth Low Energy. The short-range wireless communication unit 110 can connect to a short-range wireless communication unit 157 inside the communication apparatus 151.

The image-capturing device 111 is a device that converts an image captured by an image sensor into digital data. The digital data is temporarily stored in the RAM 105. The digital data is then converted into a predetermined image format by a program executed by the CPU 103, and stored in the external storage device 106 as image data.

The communication apparatus 151 includes a ROM 152, a RAM 153, a CPU 154, a print engine 155, a communication unit 156, a short-range wireless communication unit 157, an input interface 158, an output interface 159, an operation-and-display unit 160, a scan control unit 161, etc. By a connection mode being set, the communication apparatus 151 can operate in the set connection mode. For example, the connection mode is a mode for communicating via direct connection or a mode for communicating via infrastructure connection.

The communication unit 156 is a component that allows the communication apparatus 151 to communicate with other apparatuses, and, in the present embodiment, the communication unit 156 communicates using the IEEE 802.11 series communication standards. The communication unit 156 includes, as an access point inside the communication apparatus 151, an access point for connecting to apparatuses such as the information processing apparatus 101. Note that this access point can connect to the communication unit 109 of the information processing apparatus 101. Note that the communication unit 156 may communicate directly with the information processing apparatus 101 via wireless communication, or may communicate with the information processing apparatus 101 via the access point 131. Furthermore, the communication unit 156 may include hardware that functions as the access point, or may operate as the access point using software that causes the communication unit 156 to function as the access point. Note that, in the present embodiment, the communication unit 156 and the short-range wireless communication unit 157 are realized by a single wireless chip. Specifically, in the present embodiment, a combination chip supporting both a communication function based on the IEEE 802.11 series of communication standards and a communication function based on the short-range wireless communication method is used. However, there is no limitation to this configuration, and the communication unit 156 and the short-range wireless communication unit 157 may be realized by separate wireless chips.

The RAM 153 is formed from a DRAM or the like that requires a backup power supply. Note that, because data in the RAM 153 is retained by power being supplied from an unillustrated power source for data backup, important data such as program control variables can be stored non-volatilely. Furthermore, the RAM 153 is also used as the main memory and the work memory of the CPU 154, the RAM 153 operates as a receive buffer for temporarily storing print information received from the information processing apparatus 101, etc., and the RAM 153 stores various types of information therein.

The ROM 152 stores therein fixed data such as an OS program, data tables, and control programs to be executed by the CPU 154. In the present embodiment, the control programs stored in the ROM 152 perform software execution control such as scheduling, task switching, and interruption processing under management by the embedded OS stored in the ROM 152. Furthermore, the ROM 152 is also provided with memory areas for storing data that needs to be retained even if power is not supplied, such as setting information of the communication apparatus 151 and management data of the communication apparatus 151.

The CPU 154 is a system controller, and controls the entire communication apparatus 151. The print engine 155 forms an image on a printing medium, such as paper, using a printing agent, such as ink, based on information stored in the RAM 153 or a print job received from the information processing apparatus 101 or the like, and outputs a print result. Here, print jobs transmitted from the information processing apparatus 101, etc., involve a large amount of transmitted data and thus require high-speed communication; thus, such print jobs are received via the communication unit 156, which is capable of communicating at a higher speed than the short-range wireless communication unit 157. The short-range wireless communication unit 157 is a component for establishing short-range wireless connection with apparatuses such as the information processing apparatus 101 to execute data communication, and performs communication based on a communication method different from that of the communication unit 156. For example, the short-range wireless communication method used by the short-range wireless communication unit 157 is Bluetooth (registered trademark) or NFC. Bluetooth may be Bluetooth Classic or Bluetooth Low Energy. The short-range wireless communication unit 157 can connect to the short-range wireless communication unit 110.

The input interface 158 is an interface for receiving data input and operation instructions from a user, and is formed from a physical keyboard, buttons, a touch panel, and/or the like. Note that a configuration may be adopted such that the later-described output interface 159 and the input interface 158 are integrated into a single component so that the output of screens and the reception of operations from the user are performed by the same component. The output interface 159 is an interface that performs control for allowing the operation-and-display unit 160 to display data and provide notifications regarding the state of the communication apparatus 151.

The operation-and-display unit 160 is formed from a display unit including light-emitting diodes (LEDs), a liquid crystal display (LCD), etc., and displays data and provides notifications regarding the state of the communication apparatus 151. Note that input from the user may be received via the operation-and-display unit 160 by installing a software keyboard including keys such as numerical input keys, mode setting keys, an enter key, a cancel key, and a power key on the operation-and-display unit 160.

The scan control unit 161 includes an image sensor unit (reading unit) that scans documents placed on an unillustrated platen and an automatic document feeder (ADF). Note that the image sensor unit includes a light source that emits light to a document, and an image sensor in which elements that read and photoelectrically convert the light reflected from the document are arrayed. The scan control unit 161 acquires image data by performing analog-to-digital (A/D) conversion on an analog electric signal obtained by reading a document by means of the image sensor unit. In order to store the acquired image data in the RAM 153, the scan control unit 161 includes a circuit that performs direct memory access (DMA) transfer.

With reference to FIGS. 1A and 1B, an example of connection modes of the communication apparatus 151 will be described. A connection mode is a mode for determining the form of connection between the information processing apparatus 101 and the communication apparatus 151, and is set to the communication apparatus 151. The form of connection indicates how the information processing apparatus 101 and the communication apparatus 151 are connected. Note that, in the present embodiment, the information processing apparatus 101 and the communication apparatus 151 perform the later-described infrastructure connection and direct connection, for example.

### <Direct Connection Method>

Direct connection is a form in which, as illustrated in FIG. 1B, the apparatuses are connected directly (i.e., peer to peer) via a wireless connection without any external apparatus such as the access point 131 therebetween. As one connection mode, the communication apparatus 151 is capable of operating in a mode (direct connection mode) for communicating via direct connection. In Wi-Fi communication, there are a plurality of modes for communicating via direct connection, such as a software AP mode and a Wi-Fi Direct (registered trademark) mode. In the following, Wi-Fi Direct will be referred to as WFD.

A mode for executing direct connection via WFD is referred to as a WFD mode. WFD is a standard that has been formulated by the Wi-Fi Alliance, and is included among the IEEE 802.11 series communication standards. In the WFD mode, once a device to become a communication counterpart device is discovered based on device discovery information, the remaining wireless connection processing is performed after roles (i.e., P2P group owner (GO) and P2P client) are determined. The GO corresponds to a Wi-Fi base station (access point), and the client corresponds to a Wi-Fi client station (client). For example, this determination of roles corresponds to GO Negotiation in P2P. Note that, in the WFD mode before the determination of roles, the communication apparatus 151 is neither a base station nor a client station. Specifically, first of all, between the two devices that perform communication, one device issues device discovery information to search for a device to be connected in the WFD mode. When the other device that is to become the communication partner is discovered, a confirmation of information relating to services and functions that can be provided to one another is performed between the two devices. Note that this device provision information confirmation is optional, and not essential. This device provision information confirmation phase corresponds to Provision Discovery in P2P. Next, by mutually checking the device provision information of one another, the roles of the devices are determined, i.e., it is determined which is to be the P2P client and which is to be the P2P group owner. Next, once the client and the group owner are determined, parameters for communication via WFD are exchanged between the devices. Based on the exchanged parameters, the remaining wireless connection processing and IP connection processing are performed between the P2P client and group owner. Note that, in the WFD mode, the communication apparatus 151 may always operate as the GO without executing the above-described GO Negotiation. That is, the WFD mode in which the communication apparatus 151 operates may be the Autonomous GO mode. Furthermore, states in which the communication apparatus 151 is operating in the WFD mode include, for example, a state in which connection via WFD has not been established but the communication apparatus 151 is operating as the GO, and a state in which connection via WFD has been established and the communication apparatus 151 is operating as the GO.

In the software AP mode, between the two devices that perform communication (for example, the information processing apparatus 101 and the communication apparatus 151), one device (for example, the information processing apparatus 101) functions as a client that plays the role of requesting various services. Furthermore, the other device realizes functions of a Wi-Fi access point based on software settings. The software AP corresponds to a Wi-Fi base station, and the client corresponds to a Wi-Fi client station. In the software AP mode, the client searches for the device that is to become the software AP based on device discovery information. When the software AP is discovered, after the remaining wireless connection processing (establishment of wireless connection, etc.) is performed between the client and the software AP, IP connection processing (IP address allocation, etc.) is performed. Note that it is sufficient that commands and parameters defined in the Wi-Fi standards be used as the commands and parameters to be transmitted and received to realize the wireless connection between the client and the software AP, and description thereof is omitted herein.

In the present embodiment, if the communication apparatus 151 has established and is still in direct connection, the communication apparatus 151 operates as the base station in the network to which the communication apparatus 151 belongs. Note that the base station is the apparatus that constructs the wireless network and provides parameters for connection to the wireless network to the client station. For example, the parameters for connection to the wireless network are parameters relating to a channel used by the base station. By receiving the parameters, the client station connects to the wireless network constructed by the base station using the channel used by the base station. In the direct connection mode, the communication apparatus 151 operates as the base station; thus, the communication apparatus 151 can determine the frequency band and channel to be used for communication in the direct communication mode. In the present embodiment, the communication apparatus 151 can use a channel corresponding to the 2.4 GHz frequency band and a channel corresponding to the 5 GHz frequency band for communication in the direct connection mode. Furthermore, a user can set the frequency band to be used (or the frequency band of the channel to be used), as desired, by making a setting on a screen displayed on the communication apparatus 151. However, in the present embodiment, even if 5 GHz is selected on the screen displayed on the communication apparatus 151, the communication apparatus 151 does not use channels corresponding to the Dynamic Frequency Selection (DFS) bands included in the 5-GHz frequency band for communication in the direct connection mode. In other words, the communication apparatus 151 only uses channels corresponding to frequency bands other than the DFS bands included in the 5-GHz frequency band for communication in the direct connection mode. Note that, if a channel corresponding to a DFS band is being currently used and a radar wave of a frequency band corresponding to the channel is detected, the channel being currently used needs to be changed. Such frequency bands in which a change in channel may occur due to detection of a radar wave are referred to as DFS bands. Note that, in a case such as that in which a wireless chip supporting the DFS function is being used, for example, channels corresponding to the DFS bands in the 5-GHz frequency band may be available for use for communication in the direct connection mode.

### <Infrastructure Connection Method>

As illustrated in FIG. 1A, infrastructure connection is a form of connection in which devices that perform communication (for example, the information processing apparatus 101 and the communication apparatus 151) connect to an access point (for example, the access point 131) that controls the network of the devices to communicate with one another via the access point. As one connection mode, the communication apparatus 151 is capable of operating in a mode (infrastructure connection mode) for communicating via infrastructure connection. Note that, in the present embodiment, an access point that is outside the information processing apparatus 101 and the communication apparatus 151 and that is connected to the Internet is referred to as an external access point.

In infrastructure connection, each device searches for an access point based on device discovery information. When an access point is discovered, after the remaining wireless connection processing (establishment of wireless connection, etc.) is performed between the device and the access point, IP connection processing (IP address allocation, etc.) is performed. Note that it is sufficient that commands and parameters defined in the Wi-Fi standards be used as the commands and parameters to be transmitted and received to realize the wireless connection between the device and the access point, and description thereof is omitted herein.

In the present embodiment, when the communication apparatus 151 operates in the infrastructure connection mode, the access point 131 operates as the access point, and the communication apparatus 151 operates as the client. That is, in the present embodiment, infrastructure connection refers to a connection between the communication apparatus 151 operating as a client and an apparatus operating as an access point. If the communication apparatus 151 has established infrastructure connection and the information processing apparatus 101 has also established infrastructure connection with the access point 131, the communication apparatus 151 and the information processing apparatus 101 can communicate with one another via the access point 131. The channel to be used for communication in the infrastructure connection is determined by the access point 131; thus, the communication apparatus 151 executes communication in the infrastructure connection using the channel determined by the access point 131. In the present embodiment, the communication apparatus 151 can use a channel corresponding to the 2.4 GHz frequency band and a channel corresponding to the 5 GHz frequency band for communication in the infrastructure connection. Note that the communication apparatus 151 can also use channels corresponding to the DFS bands in the 5-GHz frequency band for communication in the infrastructure connection. Note that, in order for the information processing apparatus 101 to communicate with the communication apparatus 151 via the access point 131, the information processing apparatus 101 needs to know that the communication apparatus 151 belongs to the network which has been formed by the access point 131 and to which the information processing apparatus 101 belongs. Furthermore, if the information processing apparatus 101 and the communication apparatus 151 are connected to the access point 131 via infrastructure connection, the communication apparatus 151 can be discovered by broadcasting executed by the information processing apparatus 101.

### <Network Connection Setup Processing>

In the present embodiment, the information processing apparatus 101 executes, via wireless communication between the information processing apparatus 101 and the communication apparatus 151, network connection setup that is setup for causing the communication apparatus 151 to operate in at least one communication method out of infrastructure connection and direct connection. In the following, the network connection setup is simply referred to as connection setup. The connection setup processing in the present embodiment is also referred to as cable-less setup (CLS) because the connection setup processing is executed via wireless communication. Note that the connection setup processing may be executed via wired communication. The information processing apparatus 101 executes the connection setup processing with respect to the communication apparatus 151 when the setup application stored in the ROM 104 or the like is running. The communication apparatus 151 can operate in a connection setup mode (connection setup state) for executing the connection setup processing, and the connection setup mode is executed while the communication apparatus 151 is operating in the later-described connection setup mode. The connection setup mode will be described in detail later.

In order to cause the communication apparatus 151 to operate in the infrastructure connection mode, the information processing apparatus 101 wirelessly transmits, to the communication apparatus 151, infrastructure setup information that is setup information for causing the communication apparatus 151 to operate in the infrastructure connection mode. The infrastructure setup information includes connection information for connecting to the AP 131. For example, the connection information for connecting to the AP 131 includes a service set identifier (SSID), a password, information relating to a frequency band, etc. On the other hand, in order to cause the communication apparatus 151 to operate in the direct connection mode, the information processing apparatus 101 wirelessly transmits, to the communication apparatus 151, direct setup information that is setup information for causing the communication apparatus 151 to operate in the direct connection mode. For example, the direct setup information includes instructions for enabling the WFD function and causing the communication apparatus 151 to operate as the Group Owner, and for enabling an access point setting of the communication apparatus 151. Furthermore, the information processing apparatus 101 acquires, from the communication apparatus 151, connection information allowing the information processing apparatus 101 to directly connect to the communication apparatus 151. For example, the connection information allowing the information processing apparatus 101 to directly connect to the communication apparatus 151 includes information such as the SSID and password of the communication apparatus 151 operating in the direct connection mode.

In the present embodiment, for the transmission of the infrastructure setup information and direct setup information, and the acquisition of the connection information allowing the information processing apparatus 101 to directly connect to the communication apparatus 151 in the connection setup processing, a connection-setup direct connection between the information processing apparatus 101 and the communication apparatus 151 is used. Furthermore, connection setup processing in which Wi-Fi is used as the connection-setup direct connection is executed in the present embodiment; however, wireless communication standards other than Wi-Fi, such as Bluetooth, may be used, for example as the connection-setup direct connection. Alternatively, wired communication standards such as wired LAN and Universal Serial Bus (USB) may be used as the connection-setup direct connection.

Once Wi-Fi-based infrastructure connection or direct connection is established between the information processing apparatus 101 and the communication apparatus 151 as a result of the connection setup processing, the information processing apparatus 101 and the communication apparatus 151 can communicate with one another via the established connection. Specifically, for example, the information processing apparatus 101 can transmit, to the communication apparatus 151 via the established connection, a print job for causing the communication apparatus 151 to execute printing or a scan job for causing the communication apparatus 151 to execute scanning. Note that, while the connection setup processing can be used to cause the communication apparatus 151 to operate in the infrastructure connection mode and the direct connection mode in the present embodiment, there is no limitation to such a configuration. For example, a configuration may be adopted such that the connection setup processing can be used only to cause the communication apparatus 151 to operate in the infrastructure connection mode (i.e., the connection setup processing cannot be used to cause the communication apparatus 151 to operate in the direct connection mode).

### <Connection Setup Mode>

The communication apparatus 151 can operate in the connection setup mode. For example, the trigger causing the communication apparatus 151 to start operating in the connection setup mode may be a press of a connection-setup-mode button by the user, or the initial activation (power on) of the communication apparatus 151 after arrival. The connection-setup-mode button may be a hardware (physical) button provided to the communication apparatus 151, or a software button displayed on the operation-and-display unit 160 by the communication apparatus 151.

Once the communication apparatus 151 starts operating in the connection setup mode, the communication apparatus 151 enables Wi-Fi communication. Specifically, as processing for enabling Wi-Fi communication, the communication apparatus 151 enables an access point inside the communication apparatus 151 that is dedicated to the connection setup mode (connection-setup access point). Thus, the communication apparatus 151 enters a state in which the communication apparatus 151 can establish Wi-Fi-based direct connection with the information processing apparatus 101. Connection information (service set identifier (SSID) and password) for connecting to the connection-setup access point is stored in advance in the setup application installed to the information processing apparatus 101, and thus the information processing apparatus 101 knows, in advance, the connection information for connecting to the connection-setup access point. Due to this, differing from the connection information of the access point enabled in the direct connection mode, the connection information for connecting to the connection-setup access point cannot be changed by the user as desired.

Note that, in the connection setup mode, the communication apparatus 151 may connect to the information processing apparatus 101 via Wi-Fi Direct (WFD) rather than regular Wi-Fi. That is, the communication apparatus 151 may operate as the Group Owner and receive setup commands from the information processing apparatus 101 via WFD-based communication.

Alternatively, in the connection setup mode, the communication apparatus 151 may connect to the information processing apparatus 101 via Bluetooth. Here, Bluetooth includes Bluetooth Classic and Bluetooth Low Energy (BLE). That is, for example, the communication apparatus 151 may operate as a BLE slave device in the connection setup mode to receive setup commands from the information processing apparatus 101 via BLE-based communication. Furthermore, in the connection setup mode, the communication apparatus 151 may be capable of executing both Wi-Fi-based connection setup and BLE-based connection setup. That is, when the communication apparatus 151 starts to operate in the connection setup mode, the communication apparatus 151 may enable both Wi-Fi communication and BLE communication. Specifically, when the communication apparatus 151 starts to operate in the connection setup mode, the communication apparatus 151 may enable both the connection-setup access point and an advertising state, which is a state in which advertising information is transmitted via BLE and BLE connection is possible.

When operating in the connection setup mode, the communication apparatus 151 controls the communication unit 156 to operate as the connection-setup access point, which is enabled only during operation in the connection setup mode. The connection-setup access point is an access point that is different from the access point that is enabled during the above-described software AP mode. Furthermore, the SSID of the connection-setup access point includes a predetermined character string that can be recognized by the setup application of the information processing apparatus 101.

Furthermore, the communication apparatus 151 operating in the connection setup mode uses a predetermined communication protocol (setup communication protocol) in the communication with the information processing apparatus 101 connected to the connection-setup access point. Specifically, for example, the setup communication protocol is the Simple Network Management Protocol (SNMP). The communication apparatus 151 stops operating in the connection setup mode and disables the connection-setup access point once a predetermined amount of time elapses after the communication apparatus 151 starts operating in the connection setup mode. Furthermore, the communication apparatus 151 also disables the connection-setup access point upon receiving, from the information processing apparatus 101 while in the connection setup mode, connection information for connecting to the access point 131 and an instruction to change wireless communication operation mode.

Furthermore, the connection-setup access point is an access point that does not require a password for connection. Note that the connection-setup access point may be an access point that requires a password for connection. In such a case, the password used for connection to the connection-setup access point is a fixed password (password that cannot be changed by users) that is known in advance by the setup application.

### <Registration of Communication Apparatus to Application>

In the present embodiment, the communication apparatus 151 can be registered to the setup application by the setup application acquiring information relating to the communication apparatus 151 from the communication apparatus 151. For example, the information relating to the communication apparatus 151 is capability information of the communication apparatus 151, identification information (MAC address or the like) of the communication apparatus 151, model information of the communication apparatus 151, etc. Specifically, the capability information of the communication apparatus 151 includes a list of information of functions supported by the communication apparatus 151, information about consumables (ink and paper) that can be used in the communication apparatus 151, information indicating the printing method of the communication apparatus 151, etc. Furthermore, the setup application selects, from among one or more communication apparatuses 151 registered to the setup application, one apparatus that becomes the counterpart of the communication by the setup application. In the following, the communication apparatus 151 that is currently selected as the apparatus that is the counterpart of the communication by the setup application is referred to as the selected communication apparatus 151. Note that the selection of the apparatus that is the counterpart of the communication by the setup application may be executed by receiving from a user a selection from among the one or more communication apparatuses 151 registered to the setup application, or may be executed automatically by the setup application in accordance with a predetermined criterion. Furthermore, the apparatus that is the counterpart of the communication by the setup application may be changed by receiving from a user a selection from among the one or more communication apparatuses 151 registered to the setup application. In the present embodiment, the setup application transmits various jobs such as a print job and a scan job to the selected communication apparatus 151. That is, the selected communication apparatus 151 is the apparatus that is the transmission destination of various jobs.

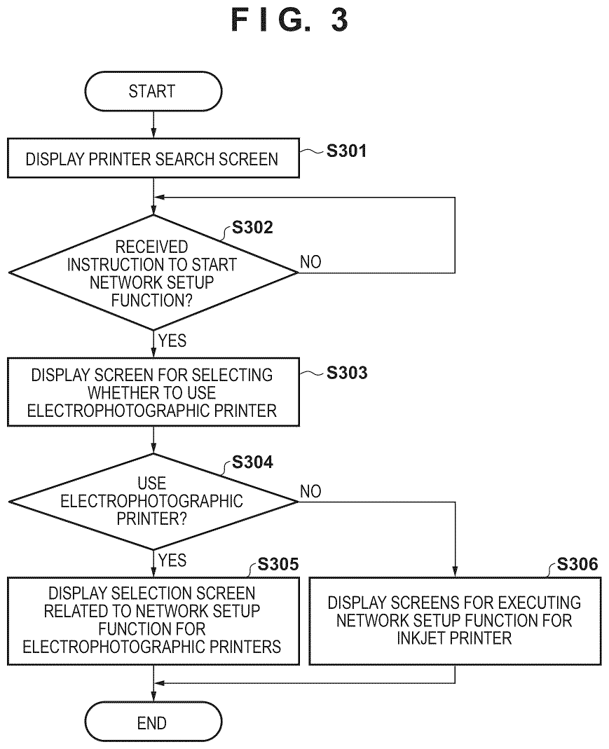

Next, a processing flow according to the present embodiment will be described with reference to FIG. 3. In the present embodiment, a user first launches a predetermined application on the information processing apparatus 101. The predetermined application is an application having a function for establishing a state in which the information processing apparatus 101 and a communication apparatus 151 can communicate with one another, and is the setup application, for example. Note that the function for establishing a state in which the information processing apparatus 101 and a communication apparatus 151 can communicate with one another is referred to as a connection setup function. Note that states in which the information processing apparatus 101 and a communication apparatus 151 can communicate with one another include a state in which the information processing apparatus 101 and the communication apparatus 151 are connected via infrastructure connection, and a state in which the information processing apparatus 101 and the communication apparatus 151 are connected in a directly connected state. Furthermore, the application may have other functions besides the connection setup function. For example, the application may have a function for causing communication apparatuses 151 to execute printing, and a function for causing communication apparatuses 151 to execute other processing, such as scanning. For example, the processing in FIG. 3 is realized by the CPU 103 loading and executing, in the RAM 105, a program stored in the ROM 104, such as the above-described application for example. Specifically, for example, the processing in FIG. 3 is started by a menu item such as “printer registration” being pressed on the setup application.

Furthermore, in the present embodiment, the predetermined application supports both printers of the inkjet printing type (inkjet printers) and printers of the electrophotographic type (electrophotographic printers). Here, inkjet printers can operate in the above-described connection setup mode, but electrophotographic printers cannot operate in the connection setup mode.

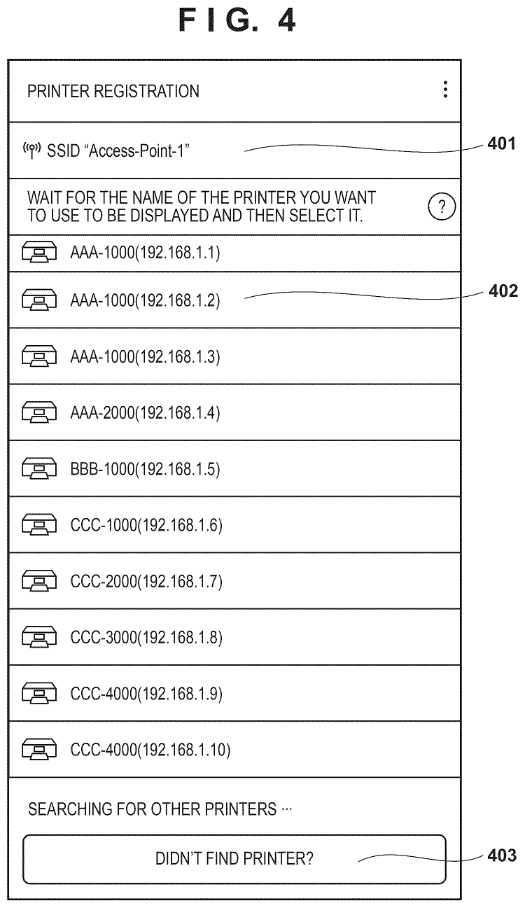

In step S301, the CPU 103 searches for communication apparatuses 151 on the network to which the information processing apparatus 101 currently belongs, and displays, on the information processing apparatus 101, a list of detected communication apparatuses 151. Specifically, for example, the search for communication apparatuses 151 is performed by instructing the OS to broadcast, on the network to which the information processing apparatus 101 currently belongs, packets of a signal requesting responses from communication apparatuses 151. Specifically, for example, the search for communication apparatuses 151 is performed by instructing the OS to broadcast packets on the network formed by the access point 131 to which the information processing apparatus 101 currently belongs. FIG. 4 is an example of a screen displayed in step S301. A connection-destination SSID 401 is an SSID indicating the connection destination of the information processing apparatus 101. A list 402 is a list of detected communication apparatuses 151.

In step S302, the CPU 103 determines whether or not an instruction to start executing the connection setup function has been received. Specifically, for example, it is determined that an instruction to start executing the connection setup function has been received if a button 403 on the screen in FIG. 4 is pressed. The button 403 is pressed by the user if the printer that the user desires to use cannot be discovered in the list 402. The printer that the user desires to use cannot be discovered in the list 402 if the printer and the information processing apparatus 101 cannot communicate with one another due to the printer that the user desires to use not being connected to the access point 131 yet. Thus, the connection setup function is executed with the press on the button 403 as a trigger to enable the information processing apparatus 101 and the printer that the user desires to use to communicate with one another. That is, in other words, the button 403 is a button for receiving an instruction to start executing the connection setup function. The processing in step S302 is repeated if it is determined in step S302 that an instruction to start executing the connection setup function has not been received, and processing advances to step S303 if it is determined in step S302 that an instruction to start executing the connection setup function has been received.

Note that, if the printer that the user desires to use is discovered in the list 402 on the screen in FIG. 4 and one of the printers displayed in the list 402 is selected, the processing in FIG. 3 is terminated, and the CPU 103 acquires information relating to the printer from the selected printer. For example, the information relating to the printer includes capability information of the printer, the MAC address of the printer, model information of the printer, etc. Specifically, for example, the capability information of the printer includes a list of information of functions supported by the printer, information about consumables (ink and paper) that can be used in the printer, and information indicating the printing method of the printer. As a result of the application on the information processing apparatus 101 acquiring such information, printing, scanning, etc., by the printer can be executed via the application.

In step S303, the CPU 103 displays a selection screen inquiring of the user whether the user desires to use an electrophotographic printer or an inkjet printer. Then, in step S304, the CPU 103 determines whether or not the use of an electrophotographic printer is desired based on the result of the selection by the user on the screen.

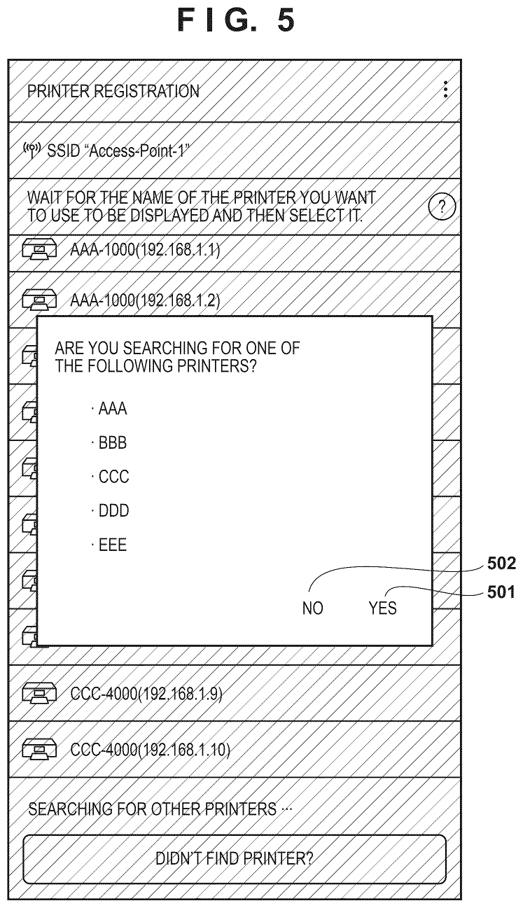

FIG. 5 is a diagram illustrating an example of the screen displayed in step S303. As illustrated in FIG. 5, a list of names of series of electrophotographic printers is displayed on the screen. Upon confirming that the name of the series of the printer that the user desires to use is displayed on the screen, the user presses a button 501. On the other hand, upon confirming that the name of the series of the printer that the user desires to use is not displayed on the screen, the user presses a button 502. If the button 501 is pressed, it is determined in step S304 that the user has chosen to use an electrophotographic printer, and processing advances to step S305. On the other hand, if the button 502 is pressed, it is determined in step S304 that the user has chosen not to use an electrophotographic printer, or that is, that the user has chosen to use an inkjet printer, and processing advances to step S306.

In such a manner, in the present embodiment, if a communication apparatus 151 is not discovered on the network to which the information processing apparatus 101 currently belongs and an instruction to start executing the connection setup function is received, display control is performed such that a screen for executing the connection setup function is displayed on a display unit so as to be switched in accordance with whether the printer that the user desires to use is an electrophotographic printer or an inkjet printer. Note that the content displayed on the screen in step S303 is not limited to the names of series of electrophotographic printers and model numbers of electrophotographic printers. For example, a configuration may be adopted such that, in step S303, a direct inquiry is made to the user as to whether the printer that the user desires to use is an electrophotographic printer.

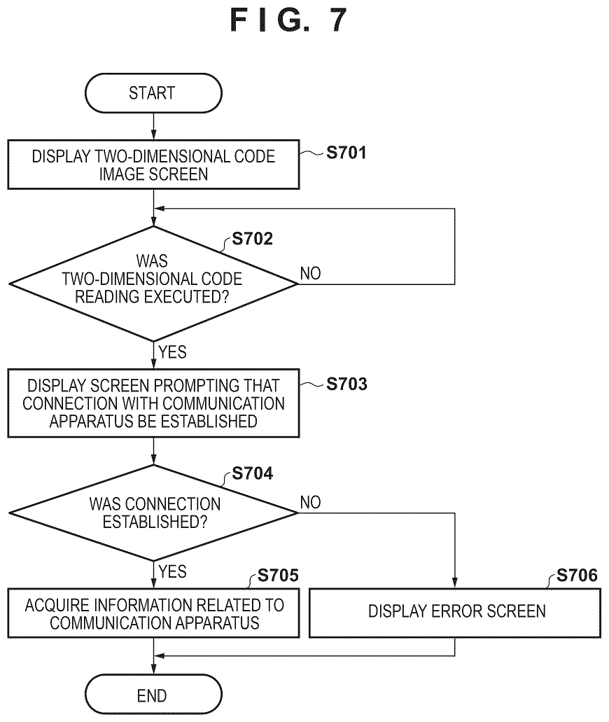

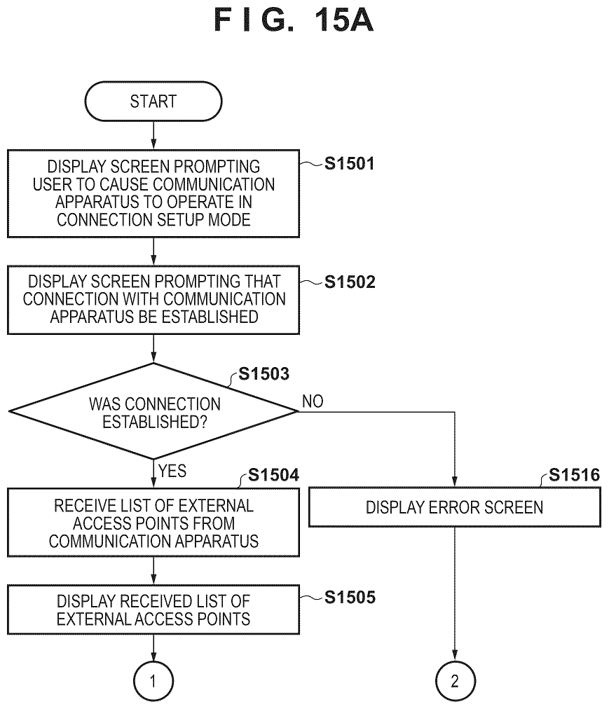

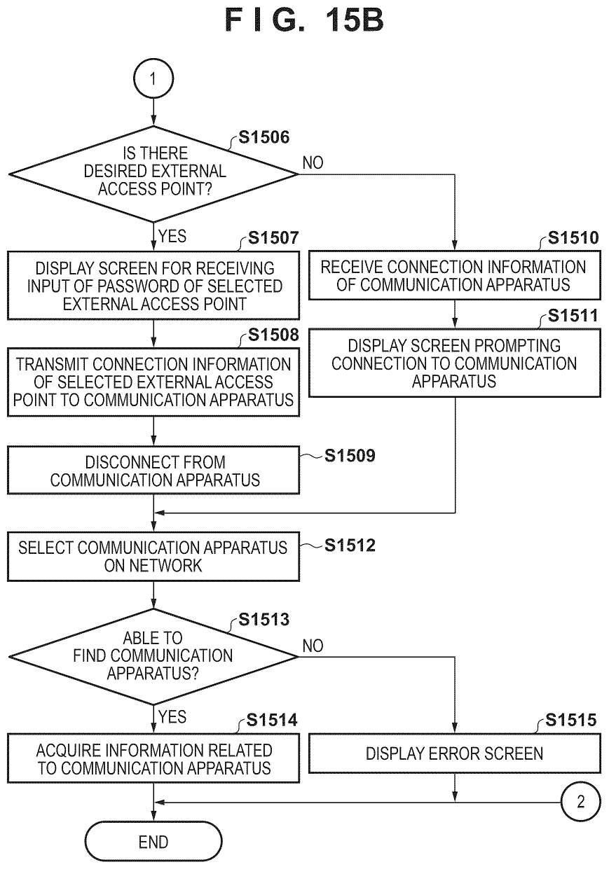

Alternatively, for example, a configuration may be adopted such that an inquiry is made to the user as to whether or not the printer that the user desires to use is capable of executing specific processing corresponding to the connection setup function. In this case, in step S304, it is determined whether or not the printer that the user desires to use is capable of executing specific processing corresponding to the connection setup function. Note that, for example, specific processing corresponding to the connection setup function is the processing in FIG. 7, 11, or 15. In step S304, buttons respectively corresponding to later-described buttons 601 and 602, and a button corresponding to the processing in FIGS. 15A and 15B may be displayed, and determination may be performed based on the pressing of such buttons. If it is determined that specific processing corresponding to the connection setup function can be executed, the processing in FIG. 7, 11, or 15 is executed, for example. On the other hand, the processing in FIG. 3 is terminated if it is determined that specific processing corresponding to the connection setup function cannot be executed.

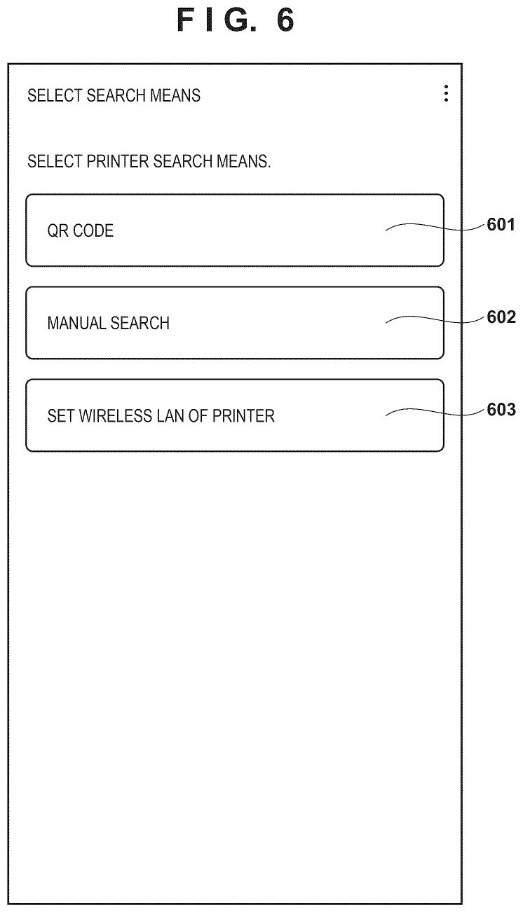

In step S305, in regard to connection setup functions for electrophotographic printers, the CPU 103 displays a screen for selecting which of the functions is to be executed. FIG. 6 is an example of the screen displayed in step S305. As illustrated in FIG. 6, a list of connection setup functions for electrophotographic printers is displayed such that the connection setup functions can be selected. A button 601 is a button for executing the connection setup function based on the processing in FIG. 7. If the button 601 is pressed, the CPU 103 executes the processing in FIG. 7.

FIG. 7 is a flowchart illustrating processing for connecting the information processing apparatus 101 and a communication apparatus 151 in the direct connection mode. For example, the processing in FIG. 7 is realized by the CPU 103 loading and executing, in the RAM 105, a program stored in the ROM 104.

After pressing the button 601, the user operates a menu screen on the communication apparatus 151 to display a code (for example, a two-dimensional code such as a QR (registered trademark) code) on the operation-and-display unit 160. For example, the code may be displayed when a predetermined item on the menu screen is selected. Here, a configuration may be adopted such that, if the button 601 is pressed, the CPU 103 displays, on the operation-and-display unit 108, a guidance screen for displaying the code on the communication apparatus 151.

In step S701, the CPU 103 displays a screen for using the information processing apparatus 101 and capturing an image of the code (for example, a two-dimensional code such as a QR (registered trademark) code) displayed on the communication apparatus 151. Then, in step S702, the CPU 103 determines whether or not reading of the code has been executed. The processing in step S702 is repeated if it is determined that the reading of the code has not been executed, and processing advances to step S703 if it is determined that the reading of the code has been executed.

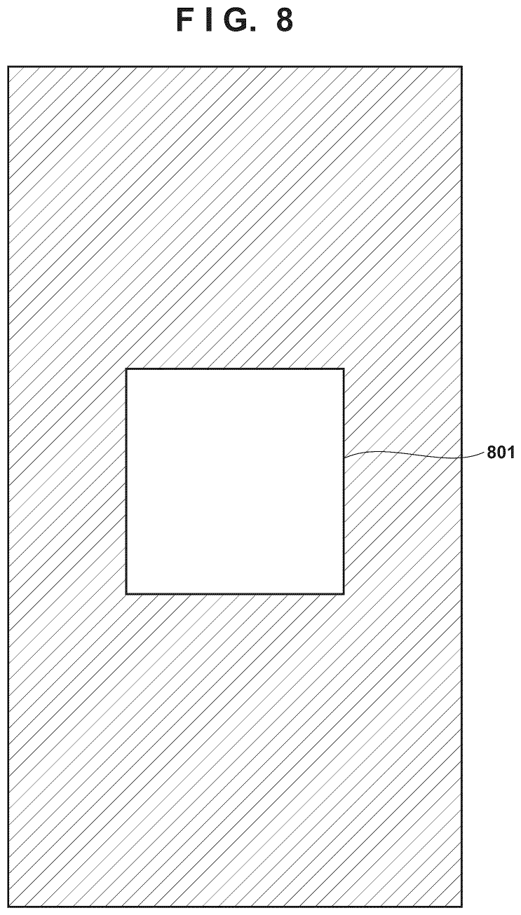

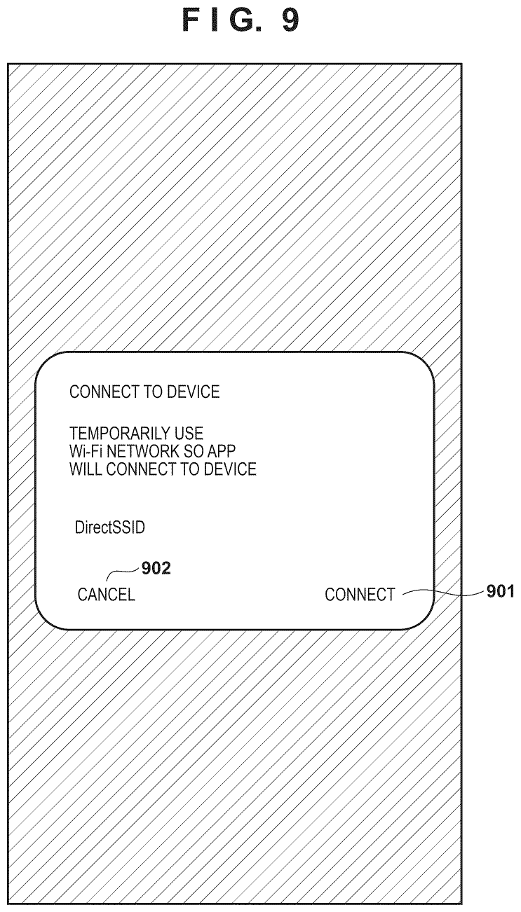

FIG. 8 is a diagram illustrating an example of a screen for using the information processing apparatus 101 and capturing an image of the code information displayed on the communication apparatus 151. When the code displayed on the communication apparatus 151 is positioned within a frame 801, reading of the code is executed. In the code displayed on the communication apparatus 151, an SSID of an access point inside the communication apparatus 151 is stored. If it is determined that the reading of the code has been executed, in step S703, the CPU 103 uses the SSID of the access point inside the communication apparatus 151 stored in the code to display a screen for connecting the information processing apparatus 101 and the communication apparatus 151 in the direct connection mode. FIG. 9 is a diagram illustrating an example of the screen displayed in step S703. As illustrated in FIG. 9, the SSID of the access point inside the communication apparatus 151, a button 901 for connecting to the access point, and a cancel button 902 are displayed on the screen. If the button 901 is pressed, the CPU 103 disconnects the connection with the currently connected access point 131 and connects to the access point inside the communication apparatus 151. If the cancel button 902 is pressed, the processing in FIG. 7 is terminated, and the screen in FIG. 6 is displayed.

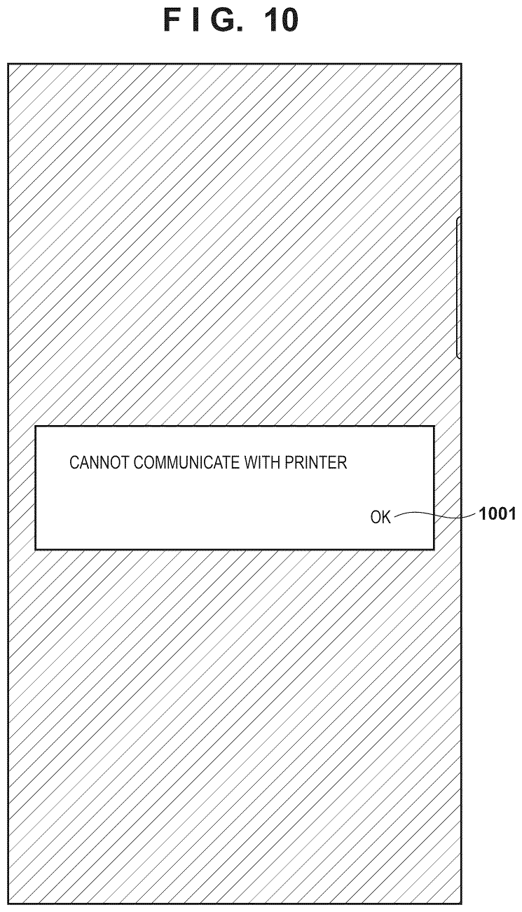

In step S704, the CPU 103 determines whether or not a connection between the information processing apparatus 101 and the communication apparatus 151 has been established. For example, if a connection between the information processing apparatus 101 and the communication apparatus 151 is established by the button 901 being pressed, the CPU 103 acquires information relating to the communication apparatus 151 from the communication apparatus 151 in step S705. For example, the information relating to the communication apparatus 151 is capability information of the communication apparatus 151, the MAC address of the communication apparatus 151, model information of the communication apparatus 151, etc. Specifically, for example, the capability information of the communication apparatus 151 is a list of information of functions supported by the communication apparatus 151, information about consumables (ink and paper) that can be used in the communication apparatus 151, and information indicating the printing method of the communication apparatus 151. As a result of the application on the information processing apparatus 101 acquiring such information, printing, scanning, etc., by the communication apparatus 151 can be executed via the application. On the other hand, if a connection between the information processing apparatus 101 and the communication apparatus 151 is not established, the CPU 103 displays an error screen in step S706. FIG. 10 is a diagram illustrating an example of the screen displayed in step S706. As illustrated in FIG. 10, a message indicating failure to communicate with a printer is displayed on the screen. If an OK button 1001 is pressed, the CPU 103 displays the screen in FIG. 6.

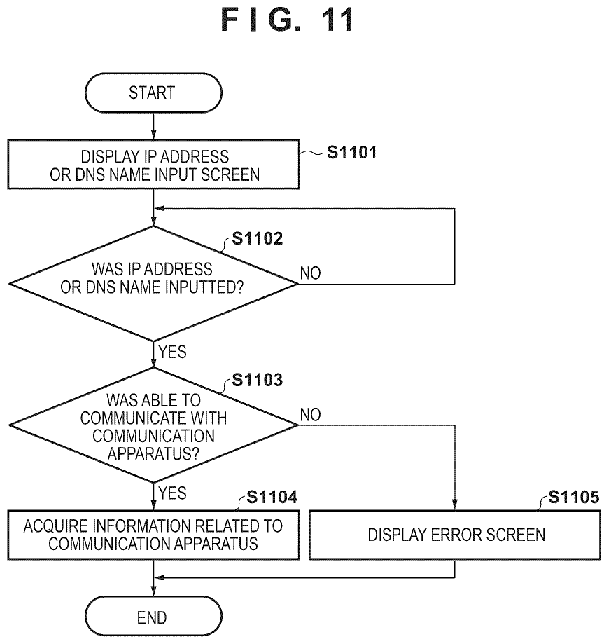

If a button 602 is pressed on the screen in FIG. 6, the CPU 103 executes the processing in FIG. 11.

FIG. 11 is a flowchart illustrating processing for connecting the information processing apparatus 101 and a communication apparatus 151 in the infrastructure connection mode. For example, the processing in FIG. 11 is realized by the CPU 103 loading and executing, in the RAM 105, a program stored in the ROM 104.

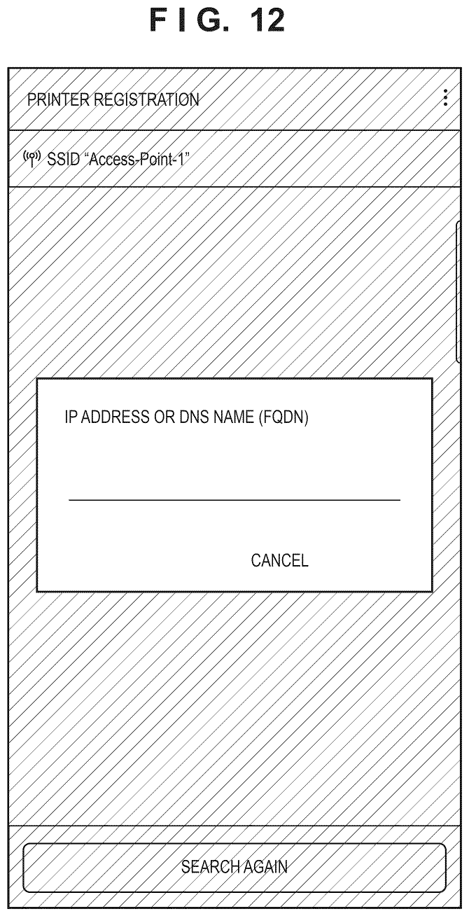

In step S1101, the CPU 103 displays a screen prompting the user to input an IP address or a DNS name of the communication apparatus 151. FIG. 12 is a diagram illustrating an example of the screen displayed in step S1101. As illustrated in FIG. 12, a screen for receiving input of an IP address or a DNS name set to the communication apparatus 151 is displayed on the screen. In step S1102, the CPU 103 determines whether or not an IP address or a DNS name has been input. The processing in step S1102 is repeated if it is determined that neither an IP address nor a DNS name has been input, and processing advances to step S1103 if it is determined that an IP address or a DNS name has been input.

In step S1103, the CPU 103 attempts to communicate with the communication apparatus 151 using the IP address or DNS name that has been input, and determines whether or not communication with the communication apparatus 151 was successful. If the communication apparatus 151 does not belong to the broadcast domain to which the information processing apparatus 101 belongs, broadcast packets transmitted from the information processing apparatus 101 do not reach the communication apparatus 151. This is why the communication apparatus 151 was not listed in the screen in FIG. 4. However, even in such a case, there is a possibility that communication can be performed with the communication apparatus 151 using the IP address or DNS name input in step S1101. Thus, in the present embodiment, through the processing in FIG. 11, an attempt to communicate with the communication apparatus 151 is made using the IP address or DNS name that has been input. Note that the communication attempted may be any communication as long as it can be determined whether communication with the communication apparatus 151 was successful.

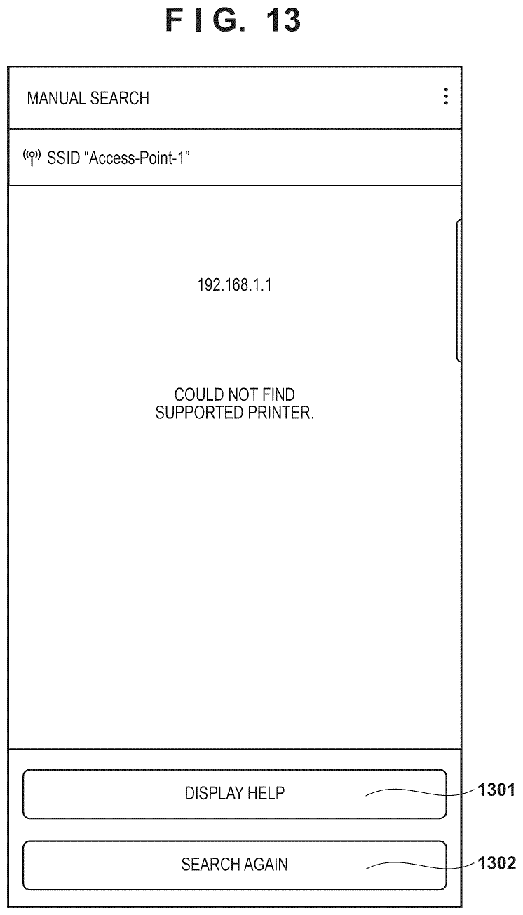

If it is determined in step S1103 that communication with the communication apparatus 151 was successful, the CPU 103 acquires information relating to the communication apparatus 151 from the communication apparatus 151 in step S1104. The information relating to the communication apparatus 151 acquired here is the same as the information acquired in step S705 in FIG. 7. Then, the processing in FIG. 11 is terminated. On the other hand, if it is determined that the communication with the communication apparatus 151 failed, the CPU 103 displays an error screen in step S1105. FIG. 13 is a diagram illustrating an example of the screen displayed in step S1105. As illustrated in FIG. 13, a message indicating that no printer could be discovered is displayed on the screen. If a “display help” button 1301 is pressed, the CPU 103 launches a Web browser and displays an online manual. If a “search again” button 1302 is pressed, the CPU 103 displays the screen in FIG. 12 again.

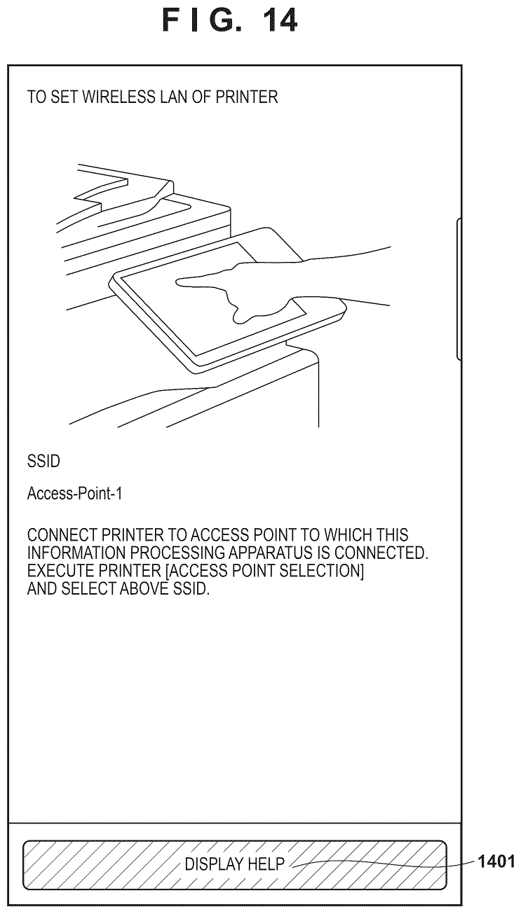

If a button 603 is pressed on the screen in FIG. 6, the CPU 103 displays a screen for presenting, to the user, a method for connecting a communication apparatus 151 to the access point by a user operating the communication apparatus 151. FIG. 14 is a diagram illustrating an example of the screen displayed when the button 603 is pressed. As illustrated in FIG. 14, a button 1401 for displaying an online manual is displayed on the screen. If the button 1401 is pressed, the CPU 103 launches the Web browser and displays the online manual. The online manual includes description of a method for connecting a communication apparatus 151 to the access point by a user operating the communication apparatus 151.

Description will be provided of a case in which it is determined in step S304 that the use of an electrophotographic printer is not desired. Specifically, for example, if the “no” button 502 is pressed on the screen in FIG. 5, processing advances from step S304 to step S306.

In step S306, the CPU 103 executes the processing in FIGS. 15A and 15B. In the processing in FIGS. 15A and 15B, screens for executing a connection setup function for inkjet printers is displayed.

FIGS. 15A and 15B are flowcharts illustrating processing for connecting the information processing apparatus 101 and a communication apparatus 151 in the infrastructure connection mode or the direct connection mode. For example, the processing in FIGS. 15A and 15B are realized by the CPU 103 loading and executing, in the RAM 105, a program stored in the ROM 104.

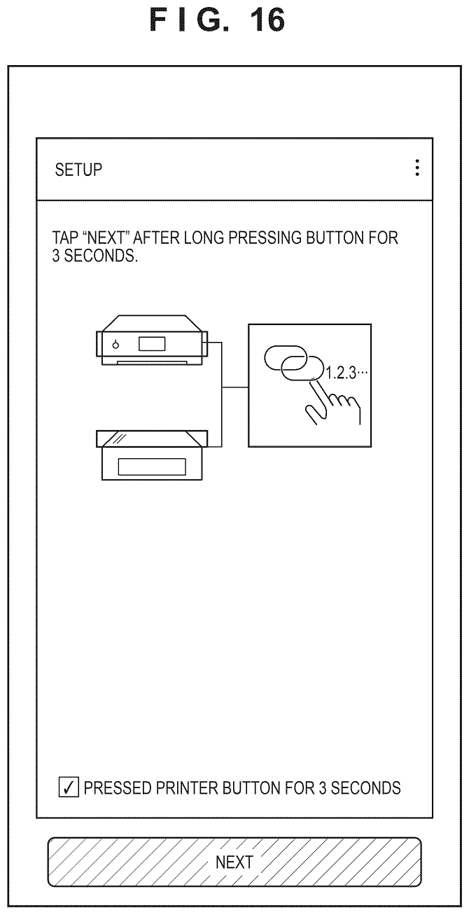

In step S1501, the CPU 103 displays a guidance screen prompting the user to cause the communication apparatus 151 to operate in the connection setup mode. FIG. 16 is a diagram illustrating an example of the screen displayed in step S1501. When the user operates the communication apparatus 151 in accordance with the screen, the communication apparatus 151 operates in the connection setup mode. In step S1501, the CPU 103 searches for the communication apparatus 151 operating in the connection setup mode after displaying the screen. Specifically, for example, a search is performed for the SSID of the access point inside the communication apparatus 151 operating in the connection setup mode. Here, description is provided assuming that the communication apparatus 151 operating in the connection setup mode is discovered.

In step S1502, the CPU 103 displays a screen prompting establishment of communication with the communication apparatus 151. Here, a screen similar to that in FIG. 9 is displayed. That is, on the screen displayed in step S1502, the SSID of the access point inside the communication apparatus 151 operating in the connection setup mode, a button for connecting to the access point, and a cancel button are displayed. If the button for connecting to the access point is pressed, a connection between the information processing apparatus 101 and the communication apparatus 151 is established.

In step S1503, the CPU 103 determines whether or not a connection between the information processing apparatus 101 and the communication apparatus 151 has been established. If it is determined that a connection between the information processing apparatus 101 and the communication apparatus 151 has been established, e.g., if the button for connecting to the access point has been pressed, processing advances to step S1504. On the other hand, if it is determined that a connection between the information processing apparatus 101 and the communication apparatus 151 has not been established, e.g., if the cancel button has been pressed, processing advances to step S1516.

The CPU 103 displays an error screen in step S1516. In step S1516, a screen similar to that in FIG. 10 is displayed. Following step S1516, the processing in FIGS. 15A and 15B is terminated.

In step S1504, the CPU 103 transmits, to the communication apparatus 151, a request for a list of external access points around the communication apparatus 151 that the communication apparatus 151 can connect to. Then, the CPU 103 receives the list of external access points from the communication apparatus 151.

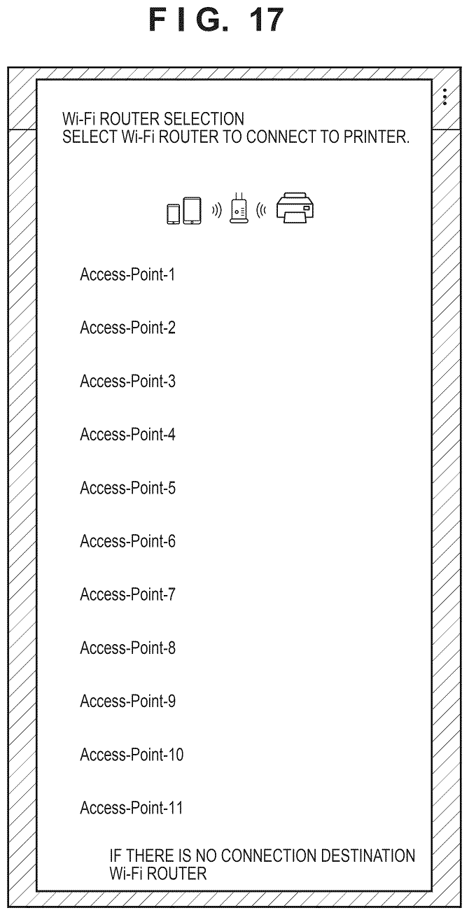

In step S1505, the CPU 103 displays the list of external access points received from the communication apparatus 151. FIG. 17 is a diagram illustrating an example of a screen displayed in step S1505. Furthermore, the screen illustrated in FIG. 17 can receive an instruction for selecting an external access point desired by the user.

In step S1506, the CPU 103 determines whether or not an external access point desired by the user is present in the list of external access points displayed in step S1505. For example, it is determined that an external access point desired by the user is present if a selection of an external access point desired by the user is received on the screen illustrated in FIG. 17.

Processing advances to step S1507 if it is determined in step S1506 that an external access point desired by the user is present. On the other hand, processing advances to step S1510 if it is determined that an external access point desired by the user is not present. For example, it is determined that an external access point desired by the user is not present if a button to be pressed when an external access point desired by the user is not present is pressed on the screen in FIG. 17.

In the following, description will be provided separately for a case in which an access point desired by the user is present (Yes in S1506) and a case in which an access point desired by the user is not present (No in S1506).

<Case in which Access Point Desired by User is Present (Yes in Step S1506)>

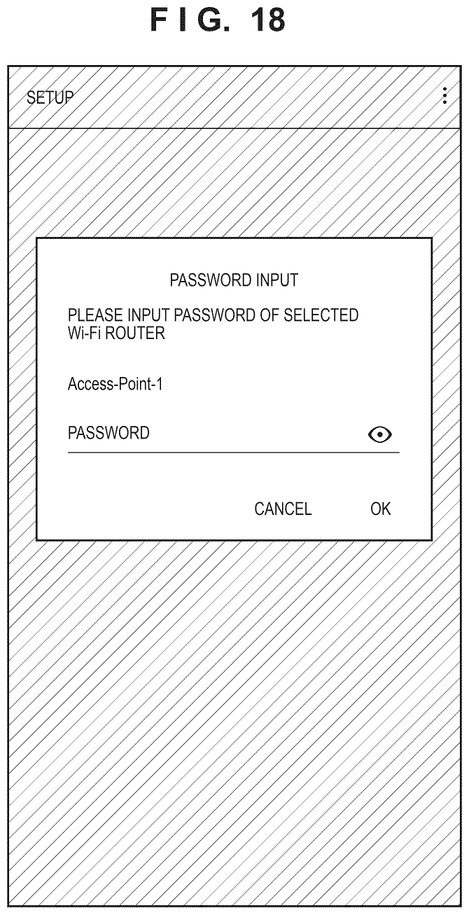

In step S1507, the CPU 103 displays a screen for receiving input of a password for the external access point selected by the user. FIG. 18 is a diagram illustrating an example of the screen displayed in step S1507. Note that step S1507 may be skipped if the external access point is set so that connection to the external access point requires no password.

In step S1508, the CPU 103 transmits, to the communication apparatus 151, connection information including the password, SSID, etc., of the external access point selected by the user. Furthermore, the CPU 103 transmits, to the communication apparatus 151, a request to connect to the external access point selected by the user. That is, the CPU 103 transmits information for establishing a state in which the communication apparatus 151 belongs to the network formed by the external access point. Note that, if the external access point is set so that connection to the external access point requires no password, only the SSID of the external access point and the request to connect to the external access point may be transmitted to the communication apparatus 151.

In step S1509, the CPU 103 disconnects the connection between the communication apparatus 151 and the information processing apparatus 101. Then, after the connection between the information processing apparatus 101 and the communication apparatus 151 in the connection setup mode has been disconnected, the CPU 103 uses a reconnection function of the OS of the information processing apparatus 101 to connect the information processing apparatus 101 and the external access point to which the information processing apparatus 101 was connected before the processing in FIGS. 15A and 15B was started. The reconnection function is a function that is automatically executed without an instruction from the application. Note that, for example, a configuration may be adopted such that information about the external access point to which the information processing apparatus 101 was connected before the processing in FIGS. 15A and 15B was started is stored in a storage area such as the RAM 105 in step S301.

Following step S1509, in step S1512, the CPU 103 searches for the communication apparatus 151 on the network formed by the external access point to which the information processing apparatus 101 is currently connected. Specifically, for example, a request for a response from the communication apparatus 151 is issued by designating the identification information (device name, serial number, or the like) of the communication apparatus 151 and broadcasting packets on the network formed by the external access point.

In step S1513, the CPU 103 determines whether or not the communication apparatus 151 has been discovered in step S1512. Processing advances to step S1514 if it is determined that the communication apparatus 151 has been discovered. On the other hand, processing advances to step S1515 if it is determined that the communication apparatus 151 has not been discovered. Specifically, for example, if a response from the communication apparatus 151 is received as a result of the search for the communication apparatus 151, it is determined that the communication apparatus 151 has been discovered. On the other hand, if no response is received from the communication apparatus 151, it is determined that the communication apparatus 151 has not been discovered.

If it is determined that the communication apparatus 151 has been discovered, the CPU 103 acquires information relating to the communication apparatus 151 from the communication apparatus 151 in step S1514. The information relating to the communication apparatus 151 acquired here is the same as the information acquired in step S705 in FIG. 7. If it is determined that the communication apparatus 151 has not been discovered, the CPU 103 displays an error screen in step S1515. Here, a screen similar to that in FIG. 10 is displayed. Following step S1514 or S1515, the processing in FIGS. 15A and 15B is terminated.

<Case in which Access Point Desired by User is not Present (No in Step S1506)>

In step S1510, the CPU 103 transmits, to the communication apparatus 151, a request for connection information of the communication apparatus 151. Then, the CPU 103 receives the connection information of the communication apparatus 151 from the communication apparatus 151. Here, for example, the connection information of the communication apparatus 151 is an SSID, a password, etc., of the access point inside the communication apparatus 151 operating in the software AP mode. That is, the connection information of the communication apparatus 151 received in step S1510 is different from the connection information of the access point inside the communication apparatus 151 operating in the connection setup mode.

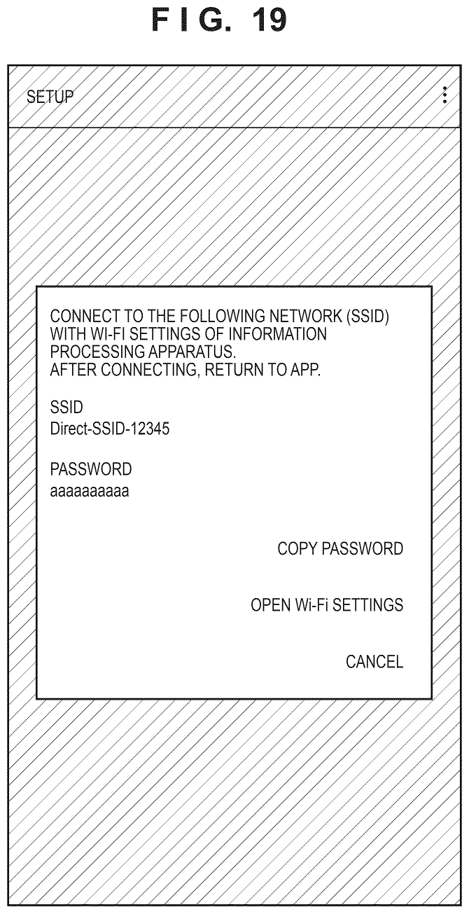

In step S1511, the CPU 103 disconnects the connection between the information processing apparatus 101 and the connection-setup access point in the communication apparatus 151 operating in the connection setup mode. Then, the CPU 103 displays a screen prompting connection of the information processing apparatus 101 and the communication apparatus 151 to one another. FIG. 19 is a diagram illustrating an example of the screen displayed in step S1511. By displaying such a screen, the user can be prompted to connect the information processing apparatus 101 and the communication apparatus 151 in the direct connection mode. That is, a state can be established in which the information processing apparatus 101 and the communication apparatus 151 can communicate with one another via the access point inside the communication apparatus 151.

Following step S1511, in step S1512, the CPU 103 searches for the communication apparatus 151 on the network to which the information processing apparatus 101 belongs. Here, if a state in which the information processing apparatus 101 and the communication apparatus 151 can communicate normally via the access point inside the communication apparatus 151 has been established in step S1511, it is determined in step S1513 that the communication apparatus 151 has been discovered, and processing advances to step S1514. On the other hand, if a state in which the information processing apparatus 101 and the communication apparatus 151 can communicate normally via the access point inside the communication apparatus 151 has not been established in step S1511 due to reasons such as a communication error, it is determined in step S1513 that the communication apparatus 151 has not been discovered, and processing advances to step S1515.

In step S1514, the CPU 103 acquires information relating to the communication apparatus 151 from the communication apparatus 151. The information relating to the communication apparatus 151 acquired here is the same as the information acquired in step S705 in FIG. 7.

The CPU 103 displays an error screen in step S1515. Here, a screen similar to that in FIG. 10 is displayed.

As described above, according to the present embodiment, the application on the information processing apparatus 101 can have the user select whether the user desires to use an electrophotographic printer or an inkjet printer, and can execute an appropriate connection setup function supported by the printer that the user desires to use.

### Second Embodiment

In the following, a second embodiment will be described focusing on the differences from the first embodiment. In the first embodiment, processing corresponding to the appropriate connection setup function is varied in accordance with whether the printer that the user desires to use is an electrophotographic printer or an inkjet printer. Here, for example, electrophotographic printers of certain models may be capable of executing processing corresponding to a connection setup function similar to that of inkjet printers. A configuration in which such a case is taken into assumption will be described in the present embodiment.

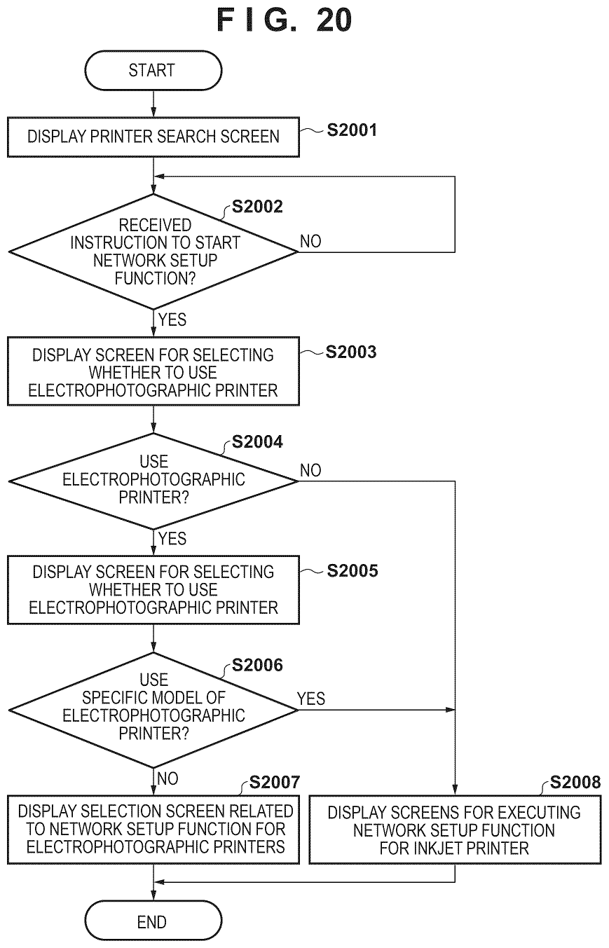

FIG. 20 is a flowchart illustrating processing executed by the application included in the information processing apparatus 101 in the present embodiment. For example, the processing in FIG. 20 is realized by the CPU 103 loading and executing, in the RAM 105, a program or application stored in the ROM 104. The processing in steps S2001 to S2004 and step S2008 are the same as those described in steps S301 to S304 and step S306 in FIG. 3, and description thereof is thus omitted.

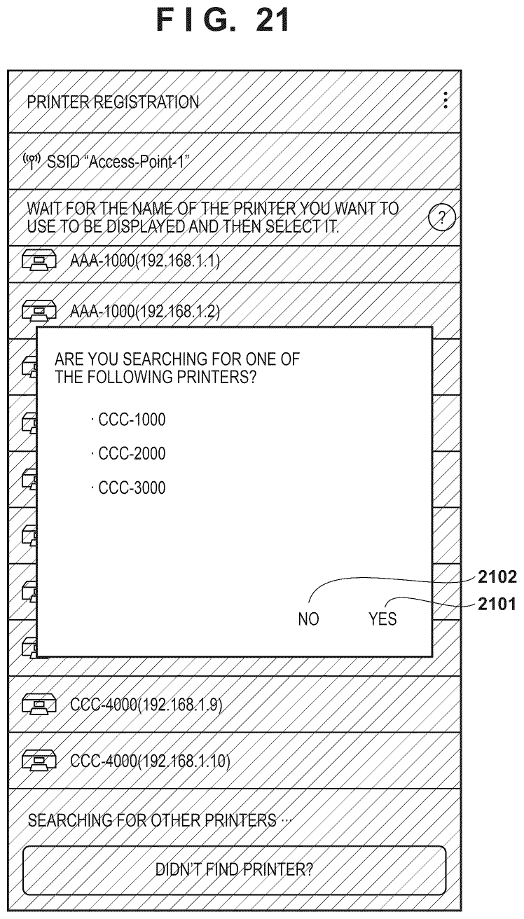

Processing advances to step S2005 if it is determined in step S2004 that the use of an electrophotographic printer is desired. In step S2005, the CPU 103 displays a screen inquiring of the user whether the user desires to use an electrophotographic printer of a specific model. FIG. 21 is a diagram illustrating an example of the screen displayed in step S2005. As illustrated in FIG. 21, model information of electrophotographic printers supporting a connection setup function similar to that of inkjet printers is displayed on the screen. The displayed model information is predetermined model information. Furthermore, a “yes” button 2101 and a “no” button 2102 are displayed on the screen. The user presses the “yes” button 2101 if the model of the electrophotographic printer that the user desires to use is included in the displayed model information, and otherwise presses the “no” button 2102.

In step S2006, the CPU 103 determines whether or not the electrophotographic printer that the user desires to use is a printer supporting a connection setup function similar to that of inkjet printers. Specifically, for example, if the button 2102 is pressed, it is determined that the electrophotographic printer that the user desires to use is a printer not supporting a connection setup function similar to that of inkjet printers, and processing advances to step S2007. On the other hand, if the button 2101 is pressed, it is determined that the electrophotographic printer that the user desires to use is a printer supporting a connection setup function similar to that of inkjet printers, and processing advances to step S2008.

The same description as that in steps S305 and S306 in FIG. 3 apply to steps S2007 and S2008, and description thereof is thus omitted.

As described above, according to the present embodiment, the application can execute an appropriate connection setup function in accordance with the model of the printer that the user desires to use.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-137859, filed Aug. 19, 2024 which is hereby incorporated by reference herein in its entirety.

What is claimed is:

1. A method for controlling an information processing apparatus, the control method comprising:
executing a first process for search for, according to a first search method, searching for one or more communication apparatuses on a network to which the information processing apparatus belongs;
receiving, from a user, a predetermined operation indicating that a communication apparatus that the user desires to use has not been discovered even though the first process for search has been executed;
in a case where the predetermined operation is received, displaying a confirmation screen for confirming whether or not the communication apparatus that the user desires to use is a communication apparatus of a predetermined type;
based on an operation indicating that the communication apparatus that the user desires to use is not a communication apparatus of the predetermined type being received by the information processing apparatus from the user after the confirmation screen is displayed, executing a first process for connection for establishing a wireless connection of the communication apparatus according to a first processing method in which information about an external access point that is an access point outside the information processing apparatus is transmitted to the communication apparatus; and
based on an operation indicating that the communication apparatus that the user desires to use is a communication apparatus of the predetermined type being received by the information processing apparatus from the user after the confirmation screen is displayed, executing at least one process out of: a second process for connection for establishing a wireless connection of the communication apparatus according to a second processing method that is different from the first processing method; and a second process for search for searching for the communication apparatus according to a second search method that is different from the first search method.

2. The control method according to claim 1,
wherein the first search method is a method in which a packet is broadcast on the network to which the information processing apparatus belongs.

3. The control method according to claim 1,
wherein the second search method is a method in which an IP address or a DNS name is used to attempt communication with a communication apparatus corresponding to the IP address or the DNS name.

4. The control method according to claim 3 further comprising
receiving input of the IP address or the DNS name from the user,
wherein the second search method is a method in which the IP address or the DNS name input by the user is used to attempt communication with a communication apparatus corresponding to the IP address or the DNS name.

5. The control method according to claim 1,
wherein the second processing method is a method in which connection information for connecting to an access point inside the communication apparatus is acquired, and a direct connection between the communication apparatus and the information processing apparatus is established using the connection information.

6. The control method according to claim 5,
wherein the connection information is acquired by the information processing apparatus capturing an image of a two-dimensional code displayed by the communication apparatus.

7. The control method according to claim 6,
wherein, based on the operation indicating that the communication apparatus that the user desires to use is a communication apparatus of the predetermined type being received by the information processing apparatus from the user after the confirmation screen is displayed, a third process for connection for establishing a wireless connection of the communication apparatus according to a third processing method that is different from the first processing method and the second processing method is further executed,
the third processing method is a method in which the communication apparatus is connected to the external access point by the user operating the communication apparatus, and
the third process for connection is a process in which a manual including description of the third processing method is displayed.

8. The control method according to claim 1,
wherein the second processing method is a method in which the communication apparatus is connected to the external access point by the user operating the communication apparatus, and
the second process for connection is a process in which a manual including description of the second processing method is displayed.

9. The control method according to claim 8,
wherein the manual includes information indicating the external access point to which the information processing apparatus is connected.

10. The control method according to claim 1,
wherein, based on the operation indicating that the communication apparatus that the user desires to use is a communication apparatus of the predetermined type being received by the information processing apparatus from the user after the confirmation screen is displayed, a screen including a region for receiving an operation for the second process for connection and a region for receiving an operation for the second process for search is displayed, and
the second process for connection is executed based on execution of the region for receiving the operation for the second process for connection, and the second process for search is executed based on execution of the region for receiving the operation for the second process for search.

11. The control method according to claim 1,
wherein communication apparatuses of the predetermined type are electrophotographic printers.

12. The control method according to claim 11,
wherein communication apparatuses that are not of the predetermined type are inkjet printers.

13. The control method according to claim 1,
wherein the confirmation screen includes a list of names of series of communication apparatuses of the predetermined type.

14. The control method according to claim 1 further comprising:
based on the operation indicating that the communication apparatus that the user desires to use is a communication apparatus of the predetermined type being received by the information processing apparatus from the user after the confirmation screen is displayed, displaying a second confirmation screen for confirming whether or not the communication apparatus that the user desires to use is a specific model among communication apparatuses of the predetermined type;
based on an operation indicating that the communication apparatus that the user desires to use is not the specific model being received by the information processing apparatus from the user after the second confirmation screen is displayed, executing the first process for search; and
based on an operation indicating that the communication apparatus that the user desires to use is the specific model being received by the information processing apparatus from the user after the second confirmation screen is displayed, executing at least one process out of the second process for connection and the second process for search.

15. The control method according to claim 1,
wherein the first process for connection includes a process for searching for the communication apparatus according to a third search method that is different from the first search method and the second search method, and
the information about the external access point is transmitted to the communication apparatus discovered by a search according to the third search method.

16. The control method according to claim 1,
wherein the first process for search is a process in which an operating system of the information processing apparatus is instructed to search for the one or more communication apparatus according to the first search method.

17. The control method according to claim 1,
wherein the second process for search is a process in which an operating system of the information processing apparatus is instructed to search for the communication apparatus according to the second search method.

18. The control method according to claim 1 further comprising
transmitting, to the communication apparatus, a print job for causing the communication apparatus to execute printing or a scan job for causing the communication apparatus to execute scanning.

19. An information processing apparatus comprising
at least one memory and at least one processor which function as:
a searching unit configured to execute a first process for search for, according to a first search method, searching for one or more communication apparatuses on a network to which the information processing apparatus belongs;
a receiving unit configured to receive, from a user, a predetermined operation indicating that a communication apparatus that the user desires to use has not been discovered even though the first process for search has been executed;
a displaying unit configured to, in a case where the predetermined operation is received, displaying a confirmation screen for confirming whether or not the communication apparatus that the user desires to use is a communication apparatus of a predetermined type; and
an executing unit configured to:
based on an operation indicating that the communication apparatus that the user desires to use is not a communication apparatus of the predetermined type being received by the information processing apparatus from the user after the confirmation screen is displayed, execute a first process for connection for establishing a wireless connection of the communication apparatus according to a first processing method in which information about an external access point that is an access point outside the information processing apparatus is transmitted to the communication apparatus; and
based on an operation indicating that the communication apparatus that the user desires to use is a communication apparatus of the predetermined type being received by the information processing apparatus from the user after the confirmation screen is displayed, execute at least one process out of: a second process for connection for establishing a wireless connection of the communication apparatus according to a second processing method that is different from the first processing method; and a second process for search for searching for the communication apparatus according to a second search method that is different from the first search method.

20. A non-transitory computer-readable storage medium that stores one or more programs including instructions, which when executed by one or more processors of an information processing apparatus, cause the information processing apparatus to function as:
a searching unit configured to execute a first process for search for, according to a first search method, searching for one or more communication apparatuses on a network to which the information processing apparatus belongs;
a receiving unit configured to receive, from a user, a predetermined operation indicating that a communication apparatus that the user desires to use has not been discovered even though the first process for search has been executed;
a displaying unit configured to, in a case where the predetermined operation is received, displaying a confirmation screen for confirming whether or not the communication apparatus that the user desires to use is a communication apparatus of a predetermined type; and
an executing unit configured to:
based on an operation indicating that the communication apparatus that the user desires to use is not a communication apparatus of the predetermined type being received by the information processing apparatus from the user after the confirmation screen is displayed, execute a first process for connection for establishing a wireless connection of the communication apparatus according to a first processing method in which information about an external access point that is an access point outside the information processing apparatus is transmitted to the communication apparatus; and
based on an operation indicating that the communication apparatus that the user desires to use is a communication apparatus of the predetermined type being received by the information processing apparatus from the user after the confirmation screen is displayed, execute at least one process out of: a second process for connection for establishing a wireless connection of the communication apparatus according to a second processing method that is different from the first processing method; and a second process for search for searching for the communication apparatus according to a second search method that is different from the first search method.
